(19) United States
(12) Patent Application Publication
(10) Pub. No.: US 2008/0036389 A1
(43) Pub. Date: Feb. 14, 2008

(54) PLASMA DISPLAY APPARATUS

(76) Inventor: Jeong Pil Choi, Suwon-si (KR)

Correspondence Address: BIRCH STEWART KOLASCH & BIRCH, PO BOX 747, FALLS CHURCH, VA, 22040-0747, US

(21) Appl. No.: 11/835,979

(22) Filed: Aug. 8, 2007

(30) Foreign Application Priority Data
Aug. 8, 2006 (KR) 10-2006-0074942
Aug. 21, 2006 (KR) 10-2006-0078736
Sep. 29, 2006 (KR) 10-2006-0096597

(51) Int. Cl. G09G 3/10; H01J 17/49

(52) U.S. Cl. 315/169.4

(57) ABSTRACT

A plasma display apparatus is disclosed. The plasma display apparatus includes a first scan module and a second scan module each including a first terminal, a second terminal, one or more third terminals, and a fourth terminal. The first terminal receives a scan bias voltage during an address period, and receives a first voltage during a sustain period. The second terminal receives a scan voltage during the address period, and receives a second voltage lower than the first voltage during the sustain period. The third terminal receives a voltage level that gradually rises to the first voltage or gradually falls from the first voltage during the sustain period. The fourth terminal of the first scan module is connected to a first scan electrode, and the fourth terminal of the second scan module is connected to a second scan electrode.

This application claims the benefit of Korean Patent Application Nos. 10-2006-0074942, 10-2006-0078736 and 10-2006-0096597 filed on Aug. 5, 2006, Aug. 21, 2006, and Sep. 29, 2006 which is hereby incorporated by reference.

### BACKGROUND OF THE DISCLOSURE

1. Field of the Disclosure

This document relates to a plasma display apparatus.

2. Description of the Related Art

A plasma display apparatus comprises a plasma display panel displaying an image and a driver for driving the plasma display panel. The plasma display panel includes a front substrate made of soda-lime glass, and a rear substrate. Barrier ribs are formed between the front substrate and the rear substrate to partition discharge cells. Each discharge cell is filled with an inert gas, and the inert gas generates a discharge due to the application of a high frequency voltage. The discharge generates vacuum ultraviolet rays, which thereby cause phosphors formed between the barrier ribs to emit light, thus displaying an image. The driver supplies a driving signal to an electrode of the plasma display panel to generate a discharge in the plasma display panel.

### SUMMARY OF THE DISCLOSURE

In one aspect, a plasma display apparatus comprises a plasma display panel including a first scan electrode and a second scan electrode, and a first scan module and a second scan module each including a first terminal, a second terminal, one or more third terminals, and a fourth terminal, wherein the first terminal receives a scan bias voltage during an address period and receives a first voltage during a sustain period, the second terminal receives a scan voltage during the address period and receives a second voltage lower than the first voltage during the sustain period, the third terminal receives a voltage level that gradually rises to the first voltage or gradually falls from the first voltage during the sustain period, and the fourth terminal of the first scan module is connected to the first scan electrode and the fourth terminal of the second scan module is connected to the second scan electrode.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates a plasma display apparatus according to a first exemplary embodiment;

FIGS. 2 to 5 illustrate methods for driving the plasma display apparatus according to the first exemplary embodiment;

FIG. 6 illustrates a plasma display apparatus according to a second exemplary embodiment;

FIG. 7 illustrates a plasma display apparatus according to a third exemplary embodiment;

FIG. 8 illustrates a plasma display apparatus according to a fourth exemplary embodiment;

FIG. 9 illustrates a plasma display apparatus according to a fifth exemplary embodiment; and

FIG. 10 illustrates a plasma display apparatus according to a sixth exemplary embodiment.

### DETAILED DESCRIPTION OF EMBODIMENTS

A plasma display apparatus comprises a plasma display panel including a first scan electrode and a second scan electrode, and a first scan module and a second scan module each including a first terminal, a second terminal, one or more third terminals, and a fourth terminal, wherein the first terminal receives a scan bias voltage during an address period and receives a first voltage during a sustain period, the second terminal receives a scan voltage during the address period and receives a second voltage lower than the first voltage during the sustain period, the third terminal receives a voltage level that gradually rises to the first voltage or gradually falls from the first voltage during the sustain period, and the fourth terminal of the first scan module is connected to the first scan electrode and the fourth terminal of the second scan module is connected to the second scan electrode.

At least one of the first scan module or the second scan module may supply a sustain signal, that gradually rises to the first voltage or gradually falls from the first voltage, to at least one of the first scan electrode or the second scan electrode during at least a portion of the sustain period.

The first voltage may be substantially equal to a sustain voltage, and the second voltage may be substantially equal to a ground level voltage.

The first scan electrode may be an odd-numbered scan electrode, and the second scan electrode may be an even-numbered scan electrode.

The first scan module may be plural and the plurality of first scan modules may be connected to the plurality of first scan electrodes, respectively. The second scan module may be plural and the plurality of second scan modules may be connected to the plurality of second scan electrodes, respectively. The plurality of first scan modules may supply the sustain signal to the plurality of first scan electrodes, and the plurality of second scan modules may supply the second voltage to the plurality of second scan electrodes.

A period of time during which the first scan module supplies the sustain signal may be different from a period of time during which the second scan module supplies the sustain signal based on a plurality of subfields.

The third terminal of each of the first scan module and the second scan module may be connected to an inductor.

The third terminals of each of the first scan module and the second scan module may be connected to a first inductor and a second inductor, respectively.

An inductance of the first inductor may be different from an inductance of the second inductor.

The number of third terminals in the first scan module or the second scan module may be two. The first switch and the second switch may be positioned outside the first scan module or the second scan module. One terminal of the first switch may be connected to one of the third terminals of the first scan module or the second scan module, and the other terminal is connected to the first inductor. One terminal of the second switch may be connected to the other third terminal of the first scan module or the second scan module, and the other terminal may be connected to the second inductor.

The number of third terminals in the first scan module or the second scan module may be two, and a first diode and a second diode may be positioned outside the first scan module and the second scan module. A cathode terminal and an anode terminal of the first diode may be connected to one of the third terminals of the first scan module or the second scan module and a first inductor, respectively. A cathode terminal and an anode terminal of the second diode may be connected to a second inductor and the other third terminal of the first scan module or the second scan module, respectively.

The first scan module and the second scan module may be integrated on a scan drive integrated circuit (IC), and the first diode and the second diode may be positioned outside the scan drive IC.

The first terminals of the first scan module and the second scan module may be connected to each other, and the third terminals of the first scan module and the second scan module may be connected to each other. The plasma display apparatus may further include a first outside switch whose one terminal is connected to the first terminal of the first scan module and the other terminal is connected to the third terminal of the second scan module.

The second terminals of the first scan module and the second scan module may be connected to each other, and the third terminals of the first scan module and the second scan module may be connected to each other. The plasma display apparatus may further include a second outside switch whose one terminal is connected to the second terminal of the first scan module and the other terminal is connected to the third terminal of the second scan module.

The first terminals of the first scan module and the second scan module may be connected to each other, and the third terminals of the first scan module and the second scan module may be connected to each other. The plasma display apparatus may further include a first sustain switch whose one terminal is connected to the third terminal of the second scan module and the other terminal receives a voltage level gradually rising to the first voltage.

The second terminals of the first scan module and the second scan module may be connected to each other, and the third terminals of the first scan module and the second scan module may be connected to each other. The plasma display apparatus may further include a second sustain switch whose one terminal is connected to the third terminal of the second scan module and the other terminal receives a voltage level gradually falling from the first voltage.

Embodiments will be described in a more detailed manner with reference to the attached drawings.

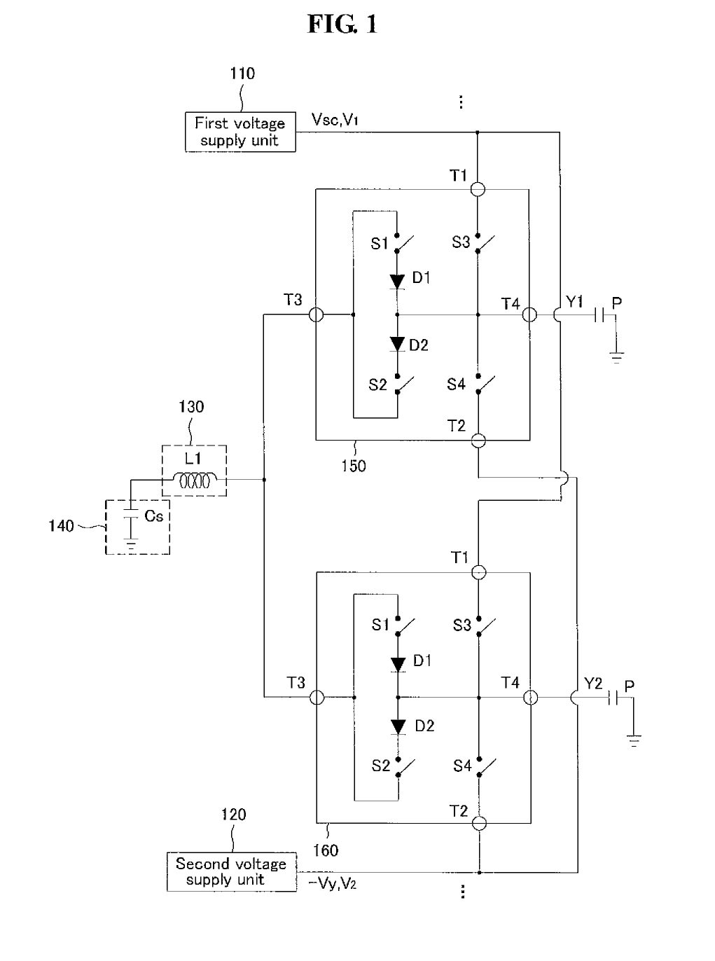

FIG. 1 illustrates a plasma display apparatus according to a first exemplary embodiment. As illustrated in FIG. 1, the plasma display apparatus according to the first exemplary embodiment includes a plasma display panel P, a first voltage supply unit 110, a second voltage supply unit 120, a resonance forming unit 130, an energy storing unit 140, a first scan module 150, and a second scan module 160.

The plasma display panel P includes a first scan electrode Y1 and a second scan electrode Y2. The first and second scan electrodes Y1 and Y2 are adjacent to each other in FIG. 1. However, the first and second scan electrodes Y1 and Y2 may not be adjacent to each other.

The first voltage supply unit 110 supplies a setup signal for accumulating wall charges inside a discharge cell during a reset period, a scan bias voltage Vsc during an address period, and a first voltage V1 during a sustain period.

The second voltage supply unit 120 supplies a set-down signal for removing the wall charges accumulated inside the discharge cell after the supply of the setup signal during the reset period, a scan voltage −Vy for selecting the discharge cells to be discharged during the address period, and a second voltage V2 lower than the first voltage V1 during the sustain period.

The resonance forming unit 130 and a capacitor component of the plasma display panel P or a capacitor component of the energy storing unit 140 form series resonance during the sustain period. The resonance forming unit 130 includes an inductor L to form the series resonance.

The energy storing unit 140 stores a supply or recovery energy during the sustain period. The energy storing unit 140 includes a capacitor Cs to store energy. The energy storing unit 140 charges a voltage (0.5×V1) corresponding to 0.5 time the first voltage V1 to the capacitor Cs. When the energy storing unit 140 supplies the voltage (0.5×V1) to the resonance forming unit 130, a series resonance forms. Hence, a voltage level of the first scan electrode Y1 or the second scan electrode Y2 gradually rises to the first voltage V1, or gradually falls from the first voltage V1.

The first scan module 150 and the second scan module 160 each include a first terminal T1, a second terminal T2, one or more third terminals T3, and a fourth terminal T4. The first terminal T1 receives the scan bias voltage Vsc during the address period, and receives the first voltage V1 during the sustain period. The second terminal T2 receives the scan voltage −Vy during the address period, and receives the second voltage V2 during the sustain period. The third terminal T3 receives a voltage level that gradually rises to the first voltage V1 or gradually falls from the first voltage V1 during the sustain period. The fourth terminal T4 of the first scan module 150 is connected to the first scan electrode Y1, and the fourth terminal T4 of the second scan module 150 is connected to the second scan electrode Y2.

When the first scan module 150 supplies the scan voltage (−Vy) to the first scan electrode Y1, the second scan module 160 may supply the scan bias voltage Vsc to the second scan electrode Y2. The first voltage V1 and the second voltage V2 may be the highest voltage and the lowest voltage of a sustain signal capable of generating a sustain discharge.

The first voltage supply unit 110 is connected to the first terminal T1, and the second voltage supply unit 110 is connected to the second terminal T2. The resonance forming unit 130 is connected to the third terminal T3.

The first scan module 150 supplies the setup signal supplied through the first terminal T1 and the set-down signal supplied through the second terminal T2 to the first scan electrode Y1 during the reset period. The first scan module 150 supplies the scan voltage −Vy supplied through the second terminal T2 to the first scan electrode Y1 during the address period. When a data signal synchronized with the scan voltage −Vy is supplied to an address electrode (not shown) of the plasma display panel P, discharge cells where a sustain discharge will occur are selected from the discharge cells positioned on the first scan electrode Y1.

The first scan module 150 supplies a sustain signal to the first scan electrode Y1. When the inductor L of the resonance forming unit 130 and the capacitor component of the plasma display panel P or the capacitor component of the energy storing unit 140 form series resonance during the sustain period, the voltage level that gradually rises to the first voltage V1 or gradually falls from the first voltage V1 is supplied to at least one of the first or second scan electrode Y1 or Y2 connected to the fourth terminal T4. The first and second scan modules 150 and 160 receive the first voltage V1 and the second voltage V2 of the sustain signal through the first and second terminals T1 and T2 during the sustain period. The first voltage V1 may correspond to the highest voltage (i.e., a sustain voltage) of the sustain signal, and the second voltage V2 may correspond to the lowest voltage (i.e., a ground level voltage) of the sustain signal.

The first and second scan modules 150 and 160 each include first to fourth switches S1 to S4, and first and second diodes D1 and D2.

One terminal of the first switch S1 is connected to the third terminal T3. When the first switch S1 is turned on, the capacitor component of the energy storing unit 140 and the resonance forming unit 130 form the series resonance.

One terminal of the second switch S2 is connected to the third terminal T3. When the second switch S2 is turned on, the capacitor component of the plasma display panel P and the resonance forming unit 130 form the series resonance.

One terminal of the third switch S3 is connected to the first terminal T1, and the other terminal is connected to the fourth terminal T4. After the first switch S1 is turned off, the third switch S3 is turned on. Hence, the first voltage V1 supplied from the first voltage supply unit 110 is supplied to the first scan electrode Y1 and the second scan electrode Y2.

One terminal of the fourth switch S4 is connected to the second terminal T2, and the other terminal is connected to the fourth terminal T4. After the second switch S2 is turned off, the fourth switch S4 is turned on. Hence, the second voltage V2 supplied from the second voltage supply unit 120 is supplied to the first scan electrode Y1 and the second scan electrode Y2.

The first scan module 150 and the second scan module 160 can simultaneously supply the sustain signal to the first scan electrode Y1 and the second scan electrode Y2, respectively. However, at least one of the first scan module 150 or the second scan module 160 may supply the sustain signal to at least one of the first scan electrode Y1 or the second scan electrode Y2. For instance, when the fourth switch S4 of the second scan module 160 is turned on while the first scan module 150 supplies the sustain signal to the first scan electrode Y1, the second scan module 160 does not supply the sustain signal. Further, when the fourth switch S4 of the first scan module 150 is turned on while the second scan module 160 supplies the sustain signal to the second scan electrode Y2, the first scan module 150 does not supply the sustain signal.

The first scan module 150 and the second scan module 160 may be installed on one scan drive integrated circuit (IC).

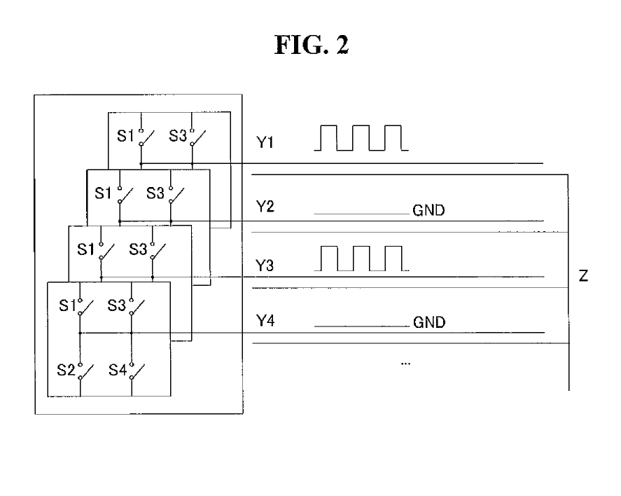

FIGS. 2 to 5 illustrate methods for driving the plasma display apparatus according to the first exemplary embodiment.

As illustrated in FIG. 2, when discharge cells positioned on even-numbered scan electrodes Y2, Y4, . . . are not selected during an address period, only the first scan module 150 connected to odd-numbered scan electrodes Y1, Y3, . . . supplies a sustain signal to the odd-numbered scan electrodes Y1, Y3, . . . during a sustain period. The first to third switches S1 to S3 of the second scan module 160 connected to the even-numbered scan electrodes Y2, Y4, . . . are turned off, and the fourth switch S4 thereof is turned on. Hence, the ground level voltage GND corresponding to the second voltage V2 is supplied to the even-numbered scan electrodes Y2, Y4, . . . .

FIG. 2 illustrated a case where the sustain signal is supplied to only the odd-numbered scan electrodes Y1, Y3, . . . . However, the sustain signal may be supplied to only the even-numbered scan electrodes Y2, Y4, . . . , and the ground level voltage GND may be supplied to the odd-numbered scan electrodes Y1, Y3, . . . .

In FIG. 2, a reference numeral Z indicates a sustain electrode of the plasma display panel P.

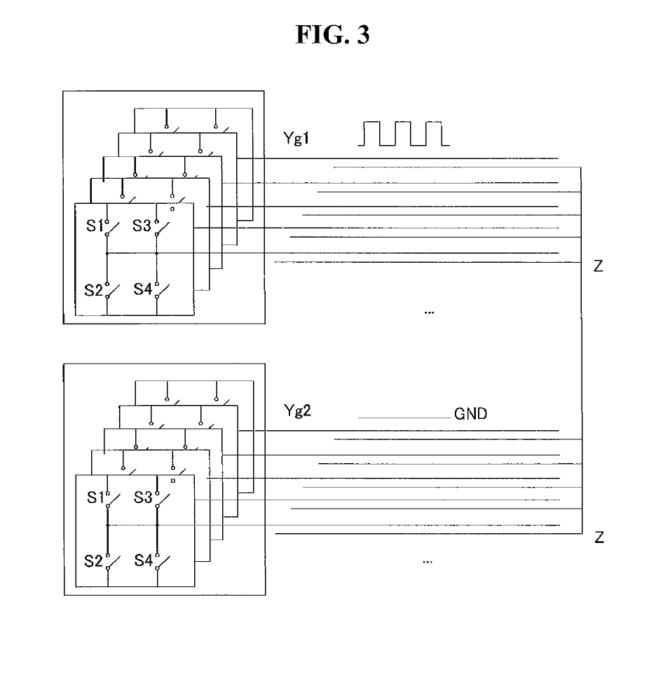

As illustrated in FIG. 3, when discharge cells positioned on scan electrodes belonging to a second scan electrode group Yg2 are not selected during an address period, only the first scan module 150 connected to scan electrodes belonging to a first scan electrode group Yg1 supplies a sustain signal to the scan electrodes belonging to the first scan electrode group Yg1 during a sustain period. The first to third switches S1 to S3 of the second scan module 160 connected to the scan electrodes belonging to the second scan electrode group Yg2 are turned off, and the fourth switch S4 thereof is turned on. Hence, the ground level voltage GND corresponding to the second voltage V2 is supplied to the scan electrodes belonging to the second scan electrode group Yg2.

FIG. 3 illustrated a case where a sustain signal is supplied to one scan electrode group and the sustain signal is not supplied to the other scan electrode group. However, the sustain signal may not be supplied to all of the scan electrode groups.

At least one of the first scan module 150 or the second scan module 160 may supply a sustain signal, that gradually rises to the first voltage or gradually falls from the first voltage, to at least one of the first scan electrode or the second scan electrode during at least a portion of a sustain period.

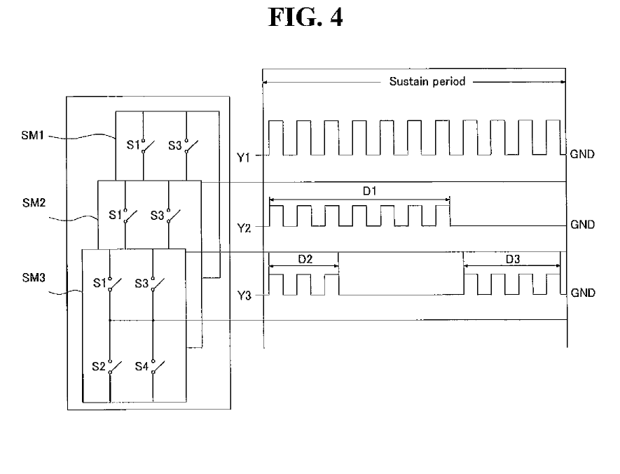

As illustrated in FIG. 4, a sustain signal may be supplied to a scan electrode during at least a portion of a sustain period of one subfield. For instance, a scan module SM1 supplies a sustain signal to the first electrode Y1 during the entire duration of a sustain period of one subfield. Another scan module SM2 supplies a sustain signal to the second electrode Y2 during a portion (D1) of a sustain period of one subfield. Another scan module SM3 supplies a sustain signal to the third electrode Y3 during a portion (D1 and D2) of a sustain period of one subfield.

A period of time during which the first scan module supplies the sustain signal may be different from a period of time during which the second scan module supplies the sustain signal based on a plurality of subfields.

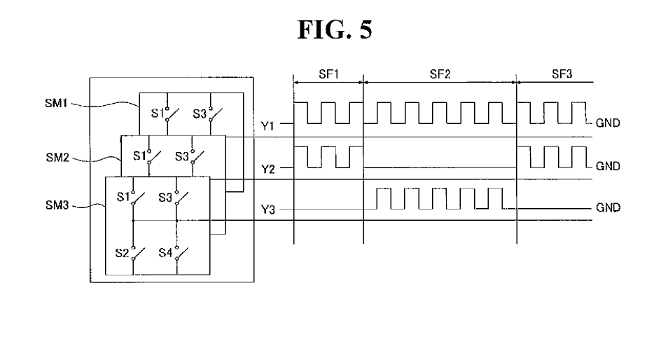

For instance, as illustrated in FIG. 5, a scan module SM1 supplies a sustain signal to the first electrode Y1 during sustain periods of all of subfields SF1, SF2 and SF3 of one frame. Another scan module SM2 supplies a sustain signal to the second electrode Y2 during the sustain periods of the first and third subfields SF1 and SF3 of one frame. Another scan module SM3 supplies a sustain signal to the third electrode Y3 during the sustain period of the second subfield SF2 of one frame.

As described above, the sustain signal is not supplied to all the scan electrodes of the plasma display panel. In other words, the sustain signal may be supplied to some of all the scan electrodes. Further, the sustain signal may be supplied during at a least a portion of the sustain period or during a portion of all the subfields. Hence, power consumption can be reduced.

Since the scan bias voltage Vsc and the scan voltage −Vy as well as the sustain signal are supplied through the third and fourth switches S3 and S4 of FIG. 1, the plasma display apparatus with the simple structure can be achieved.

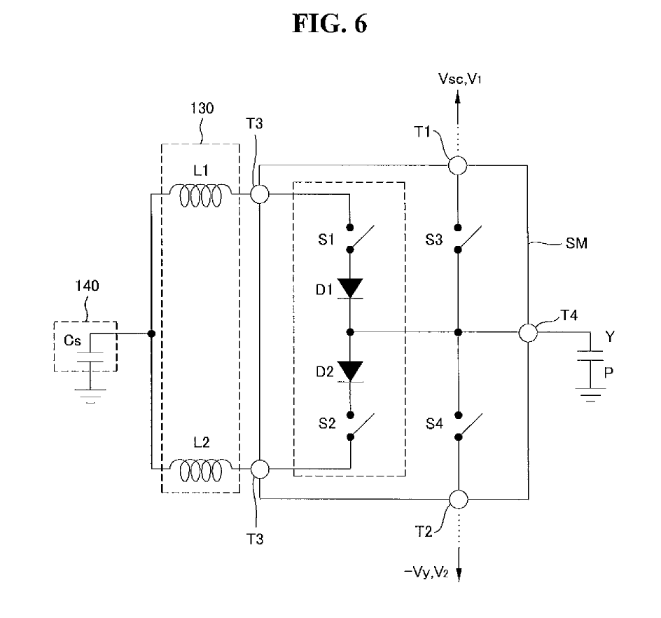

FIG. 6 illustrates a plasma display apparatus according to a second exemplary embodiment. The number of third terminals T3 in the first and second scan modules 150 and 160 of FIG. 1 is one. However, in FIG. 6, the number of third terminals is plural.

Third terminals T3 of a scan module SM are connected to a first inductor L1 and a second inductor L2, respectively. A common terminal of the first inductor L1 and the second inductor L2 is connected to a capacitor Cs of an energy storing unit 140.

The first inductor L1 and a capacitor component of a plasma display panel P form series resonance in response to a turn-on operation of a first switch S1. A voltage level of a scan electrode Y gradually rises to a first voltage V1.

The second inductor L2 and the capacitor Cs of the energy storing unit 140 form series resonance in response to a turn-on operation of a second switch S2. A voltage level of the scan electrode Y gradually falls from the first voltage V1.

An inductance of the first inductor L1 may be different from an inductance of the second inductor L2. For instance, when an inductance of the first inductor L1 is smaller than an inductance of the second inductor L2, a period of time required to raise a voltage level of the scan electrode Y from a second voltage V2 to the first voltage V1 is reduced. Therefore, an intensity of a sustain discharge can increase.

when an inductance of the first inductor L1 is substantially equal to an inductance of the second inductor L2, the structure of the plasma display panel P can be simplified.

When an inductance of the first inductor L1 is larger than an inductance of the second inductor L2, a period of time required to lower a voltage level of the scan electrode Y from the first voltage V1 to the second voltage V2 is reduced. Therefore, the number of sustain signals assigned during a sustain period can increase.

An anode terminal of a first diode D1 and a cathode terminal of a second diode D2 are connected to one terminal of the first switch S1 and one terminal of the second switch S2, respectively. A cathode terminal of the first diode D1 and an anode terminal of the second diode D2 are connected to each other. The first diode D1 and the second diode D2 each prevent an inverse current flowing from the cathode terminal into the anode terminal.

A scan bias voltage Vsc and a scan voltage −Vy as well as the sustain signal are supplied through a third switch S3 and a fourth switch S4, the plasma display panel P with the simple structure can be achieved.

Since the first inductor L1 and the second inductor L2 are positioned outside the scan module SM, the plurality of the scan modules SM can be easily integrated on one integrated circuit (IC).

Since the plasma display apparatus according to the second exemplary embodiment includes the first inductor L1 and the second inductor L2, heat generated in the plasma display apparatus is reduced as compared with a case of forming series resonance through one inductor.

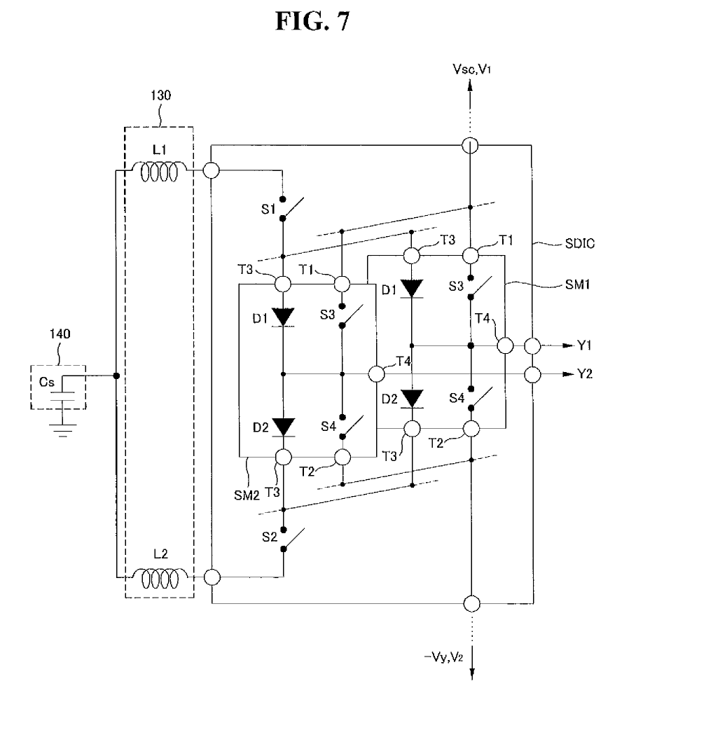

FIG. 7 illustrates a plasma display apparatus according to a third exemplary embodiment.

A first scan module SM1 and a second scan module SM2 each include a first diode D1, a second diode D2, a third switch S3, a fourth switch S4, and a third terminal T3. The number of third terminals T3 in each of the first scan module SM1 and the second scan module SM2 is two.

A first switch S1 and a second switch S2 are positioned outside the first scan module SM1 and the second scan module SM2.

One terminal of the first switch S1 is connected to one of the third terminals T3 of the first scan module SM1 or the second scan module SM2, and the other terminal is connected to the first diode D1.

One terminal of the second switch S2 is connected to the other third terminal T3 of the first scan module SM1 or the second scan module SM2, and the other terminal is connected to the first diode D1.

The first terminals T1 positioned in the upside of the first scan module SM1 and the second scan module SM2 are connected to each other. Further, the second terminals T2 positioned in the downside of the first scan module SM1 and the second scan module SM2 are connected to each other.

The third terminals T3 positioned in the upside of the first scan module SM1 and the second scan module SM2 are connected to each other. Further, the third terminals T3 positioned in the downside of the first scan module SM1 and the second scan module SM2 are connected to each other.

Since the first and second switches S1 and S2 in FIG. 6 are positioned inside the scan module SM, the number of components constituting the scan module SM increases. On the other hand, since the first and second switches S1 and S2 in FIG. 7 are positioned outside the first and second scan modules SM1 and SM2, the number of components constituting each of the first and second scan modules SM1 and SM2 decreases.

The first and second scan modules SM1 and SM2 of FIG. 7 may be integrated on a scan drive IC SDIC.

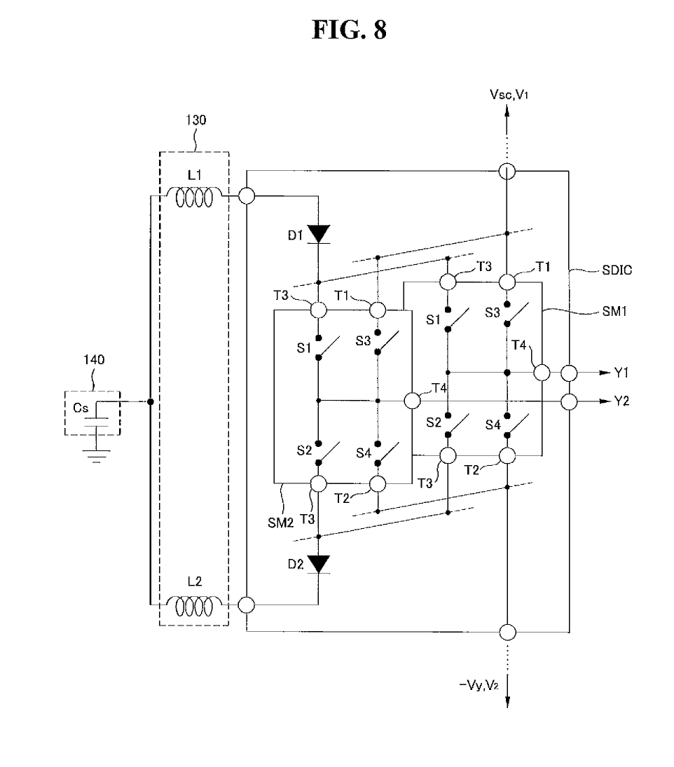

FIG. 8 illustrates a plasma display apparatus according to a fourth exemplary embodiment. In FIG. 8, a first diode D1 and a second diode D2 are positioned outside a first scan module SM1 and a second scan module SM2.

In FIG. 7, the first scan module SM1 and the second scan module SM2 each include the first and second diodes D1 and D2. However, in FIG. 8, the plasma display apparatus including the first scan module SM1 and the second scan module SM2 are operated through two diodes (i.e., the first and second diodes D1 and D2). Accordingly, the number of components constituting the first scan module SM1 and the second scan module SM2 decreases.

The first and second scan modules SM1 and SM2 of FIG. 8 may be integrated on a scan drive IC SDIC.

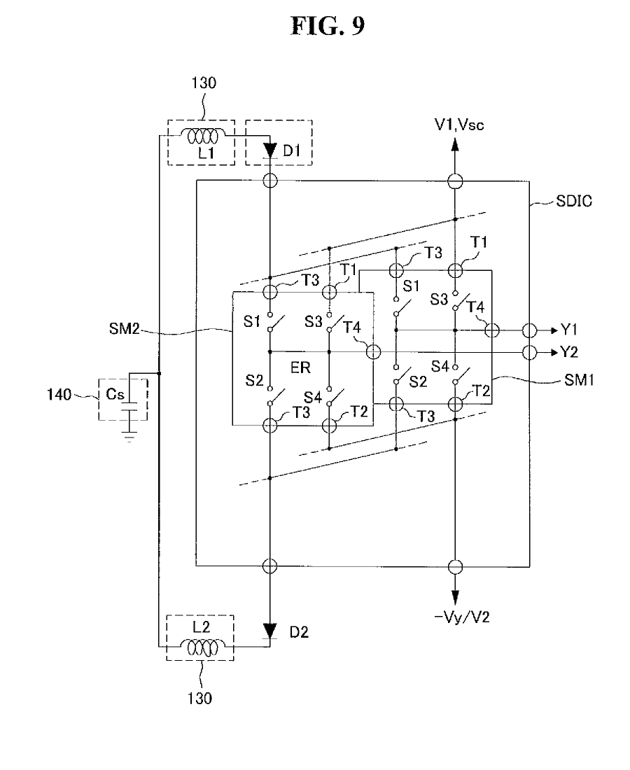

FIG. 9 illustrates a plasma display apparatus according to a fifth exemplary embodiment. In FIG. 8, the first and second diodes D1 and D2 are positioned inside the scan drive IC on which the first scan module SM1 and the second scan module SM2 are integrated. However, in FIG. 9, first and second diodes D1 and D2 are positioned outside a scan drive IC SDIC on which a first scan module SM1 and a second scan module SM2 are integrated. Accordingly, the number of components constituting the scan drive IC decreases.

Because a distance between first and second inductors L1 and L2 series resonance forming and the scan drive IC SDIC and a plasma display panel P is reduced, a noise generated when the plasma display panel P is driven is reduced.

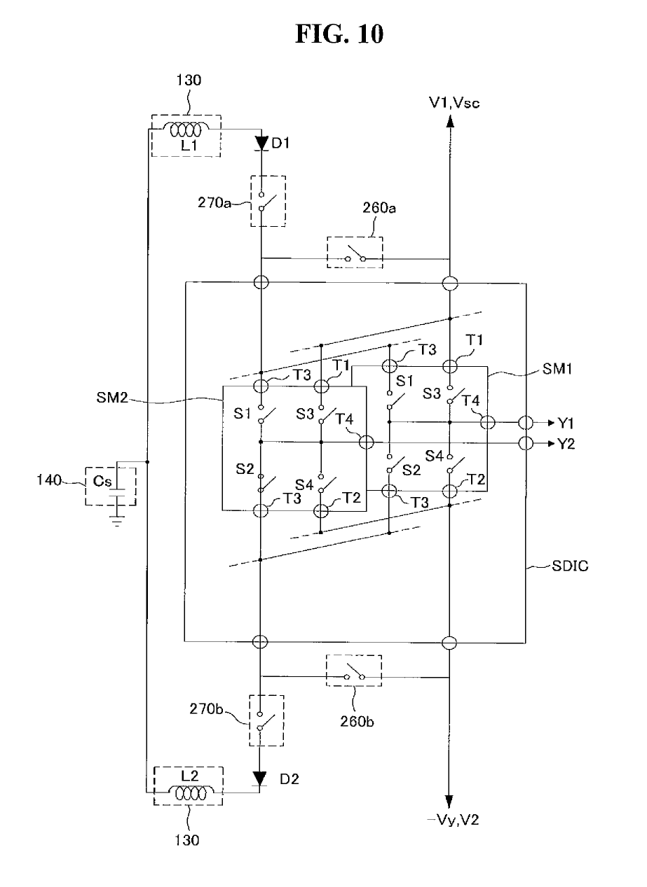

FIG. 10 illustrates a plasma display apparatus according to a sixth exemplary embodiment.

Unlike the plasma display apparatus of FIG. 9, the plasma display apparatus of FIG. 10 further includes first and second outside switches 260a and 260b and first and second sustain switches 270a and 270b.

First terminals T1 of first and second scan modules SM1 and SM2 are connected to each other, and third terminals T3 positioned in the upside of the first and second scan modules SM1 and SM2 are connected to each other. One terminal of the first outside switch 260a is connected to the first terminal T1 of the first scan module SM1, and the other terminal is connected to the third terminal T3 positioned in the upside of the second scan module SM2. One terminal of the first sustain switch 270a is connected to the third terminal T3 positioned in the upside of the second scan module SM2, and the other terminal receives a voltage level gradually rising to a first voltage V1.

Second terminals T2 of the first and second scan modules SM1 and SM2 are connected to each other, and third terminals T3 positioned in the downside of the first and second scan modules SM1 and SM2 are connected to each other. One terminal of the second outside switch 260b is connected to the second terminal T2 of the first scan module SM1, and the other terminal is connected to the third terminal T3 positioned in the downside of the second scan module SM2. One terminal of the second sustain switch 270b is connected to the third terminal T3 positioned in the downside of the second scan module SM2, and the other terminal receives a voltage level gradually falling from the first voltage V1.

When the first sustain switch 270a is turned on during a sustain period, a first inductor L1 and a capacitor component of a plasma display panel P form series resonance. Hence, when a first switch S1 of at least one of the first scan module SM1 or the second scan module SM2 is turned on, the voltage level gradually rising to the first voltage V1 is supplied to at least one of a first scan electrode Y1 or a second scan electrode Y2.

When the second sustain switch 270b is turned on during the sustain period, a second inductor L2 and a capacitor component of an energy storing unit 140 form series resonance. Hence, when a second S2 of at least one of the first scan module SM1 or the second scan module SM2 is turned on, the voltage level gradually falling from the first voltage V1 is supplied to at least one of the first scan electrode Y1 or the second scan electrode Y2.

When the first outside switch 260a is turned on during an address period or the sustain period and the first switch S1 and a third switch S3 of each of the first and second scan modules SM1 and SM2 are simultaneously turned on, a scan bias voltage Vsc or the first voltage V1 is supplied to the first scan electrode Y1 and the second scan electrode Y2 through the first and third switches S1 and S3 of each of the first and second scan modules SM1 and SM2. Therefore, the scan bias voltage Vsc or the first voltage V1 is stably supplied. When the first outside switch 260a is turned on, the first or third switch S1 or S3 of each of the first and second scan modules SM1 and SM2 may be turned on.

When the second outside switch 260b is turned on during the address period or the sustain period and the second switch S2 and a fourth switch S4 of each of the first and second scan modules SM1 and SM2 are simultaneously turned on, a scan voltage −Vy or a second voltage V2 is supplied to the first scan electrode Y1 and the second scan electrode Y2 through the second and fourth switches S2 and S4 of each of the first and second scan modules SM1 and SM2. Therefore, the scan voltage −Vy or the second voltage V2 is stably supplied. When the second outside switch 260b is turned on, the second or fourth switch S2 or S4 of each of the first and second scan modules SM1 and SM2 may be turned on.

Anode terminals of a first diode D1 and a second diode D2 are connected to the first inductor L1 and the second sustain switch 270b, respectively. Cathode terminals of the first diode D1 and the second diode D2 are connected to the first sustain switch 270a and the second inductor L2, respectively.

The first and second diodes D1 and D1 prevent an inverse current flowing from the cathode terminal into the anode terminal.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
a plasma display panel including a first scan electrode and a second scan electrode; and
a first scan module and a second scan module each including a first terminal, a second terminal, one or more third terminals, and a fourth terminal, wherein the first terminal receives a scan bias voltage during an address period and receives a first voltage during a sustain period, the second terminal receives a scan voltage during the address period and receives a second voltage lower than the first voltage during the sustain period, the third terminal receives a voltage level that gradually rises to the first voltage or gradually falls from the first voltage during the sustain period, and the fourth terminal of the first scan module is connected to the first scan electrode and the fourth terminal of the second scan module is connected to the second scan electrode.

2. The plasma display apparatus of claim 1, wherein at least one of the first scan module or the second scan module supplies a sustain signal, that gradually rises to the first voltage or gradually falls from the first voltage, to at least one of the first scan electrode or the second scan electrode during at least a portion of the sustain period.

3. The plasma display apparatus of claim 1, wherein the first voltage is substantially equal to a sustain voltage, and the second voltage is substantially equal to a ground level voltage.

4. The plasma display apparatus of claim 1, wherein the first scan electrode is an odd-numbered scan electrode, and the second scan electrode is an even-numbered scan electrode.

5. The plasma display apparatus of claim 2, wherein the first scan module is plural and the plurality of first scan modules are connected to the plurality of first scan electrodes, respectively, and the second scan module is plural and the plurality of second scan modules are connected to the plurality of second scan electrodes, respectively,
wherein the plurality of first scan modules supply the sustain signal to the plurality of first scan electrodes, and the plurality of second scan modules supply the second voltage to the plurality of second scan electrodes.

6. The plasma display apparatus of claim 2, wherein a period of time during which the first scan module supplies the sustain signal is different from a period of time during which the second scan module supplies the sustain signal based on a plurality of subfields.

7. The plasma display apparatus of claim 1, wherein the third terminal of each of the first scan module and the second scan module is connected to an inductor.

8. The plasma display apparatus of claim 1, wherein the third terminals of each of the first scan module and the second scan module are connected to a first inductor and a second inductor, respectively.

9. The plasma display apparatus of claim 8, wherein an inductance of the first inductor is different from an inductance of the second inductor.

10. The plasma display apparatus of claim 1, wherein the number of third terminals in the first scan module or the second scan module is two,
the first switch and the second switch are positioned outside the first scan module or the second scan module,
one terminal of the first switch is connected to one of the third terminals of the first scan module or the second scan module, and the other terminal is connected to the first inductor, and
one terminal of the second switch is connected to the other third terminal of the first scan module or the second scan module, and the other terminal is connected to the second inductor.

11. The plasma display apparatus of claim 1, wherein the number of third terminals in the first scan module or the second scan module is two,
a first diode and a second diode are positioned outside the first scan module and the second scan module,
a cathode terminal and an anode terminal of the first diode are connected to one of the third terminals of the first scan module or the second scan module and a first inductor, respectively, and
a cathode terminal and an anode terminal of the second diode are connected to a second inductor and the other third terminal of the first scan module or the second scan module, respectively.

12. The plasma display apparatus of claim 11, wherein the first scan module and the second scan module are integrated on a scan drive integrated circuit (IC), and
the first diode and the second diode are positioned outside the scan drive IC.

13. The plasma display apparatus of claim 1, wherein the first terminals of the first scan module and the second scan module are connected to each other, and the third terminals of the first scan module and the second scan module are connected to each other, and
the plasma display apparatus further includes a first outside switch whose one terminal is connected to the first terminal of the first scan module and the other terminal is connected to the third terminal of the second scan module.

14. The plasma display apparatus of claim 1, wherein the second terminals of the first scan module and the second scan module are connected to each other, and the third terminals of the first scan module and the second scan module are connected to each other, and
the plasma display apparatus further includes a second outside switch whose one terminal is connected to the second terminal of the first scan module and the other terminal is connected to the third terminal of the second scan module.

15. The plasma display apparatus of claim 1, wherein the first terminals of the first scan module and the second scan module are connected to each other, and the third terminals of the first scan module and the second scan module are connected to each other, and
the plasma display apparatus further includes a first sustain switch whose one terminal is connected to the third terminal of the second scan module and the other terminal receives a voltage level gradually rising to the first voltage.

16. The plasma display apparatus of claim 1, wherein the second terminals of the first scan module and the second scan module are connected to each other, and the third terminals of the first scan module and the second scan module are connected to each other, and
the plasma display apparatus further includes a second sustain switch whose one terminal is connected to the third terminal of the second scan module and the other terminal receives a voltage level gradually falling from the first voltage.
